(19) United States
(12) Patent Application Publication
(10) Pub. No.: US 2003/0171988 A1
(43) Pub. Date: Sep. 11, 2003

(54) Advertisement delivery system, print system and record medium

(75) Inventor: Masaru Sugihara, Kato (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/270,190

(22) Filed: Oct. 15, 2002

(30) Foreign Application Priority Data
Mar. 7, 2002 (JP) 2002-062058

(51) Int. Cl. G06F 17/60

(52) U.S. Cl. 705/14

(57) ABSTRACT

An advertisement delivery system that can deliver advertisements efficiently and effectively is provided. The advertisement delivery system comprises an advertisement database for storing advertising information that indicates items of property for each advertisement, a desired property database for storing desire information of each customer about a desired property, a transmission target address database for storing a network address of a printer for each customer, a receiving intention deciding portion for deciding whether or not the consumer has an intention to receive the advertisement in accordance with the customer's desire information and the advertising information of the advertisement, a print data transmitting portion for transmitting the print data of the advertisement to the network address of the customer if it is decided that the customer has an intention to receive the advertisement, a reception record database for storing reception record information for each customer, and a value calculating portion for calculating a value that is given to the customer as compensation for receiving the advertisement in accordance with the customer's reception record information.

### BACKGROUND OF THE INVENTION

1. Field of the Invention

The present invention relates to an advertisement delivery system for delivering advertisements to each home via a network.

2. Description of the Prior Art

Conventionally, printed matters of advertisements, i.e., leaflets are delivered to each home together with newspapers or are handed to people on a street at random. Such delivery method requires a lot of leaflets but earns little response from people who received the leaflet. In addition, it requires high cost of labor and paper.

Therefore, sponsors want to improve the efficiency of delivery and reduce the cost of delivery by delivering leaflets to limited people who seem to have an interest in contents of the advertisement. Furthermore, a person who receives the leaflet wants to receive only a leaflet of interesting contents but does not want to receive a leaflet of non-interesting contents, which is a waste and becomes garbage.

A method for solving such problems is proposed. For example, Japanese unexamined patent publication No. 2001-134655 discloses a method of delivering bargain sale information to wishers using an electronic mail system.

However, an electronic mail usually transmits information only by characters, so it gives little impact. Although a so-called HTML (Hypertext Markup Language) mail can contain image information, it is difficult to make a layout such as a leaflet of newspapers that can be read easily. Therefore, it gives still little impact to a reader.

When using a personal computer to read an electronic mail, it is usually required to connect to the Internet service provider by dialing up. Therefore, even if latest information is delivered, it can be left unread for some time. In addition, leaflets are usually read while drinking coffee, talking or watching television, but information through an electronic mail is inconvenient and laborious to read compared with a leaflet in a newspaper.

As mentioned above, although an electronic mail can eliminate waste and reduce cost by delivering information to selected people easily, it can impair merits of the conventional leaflets in impact to readers and in easiness of reading. In other words, the method of delivering an advertisement by an electronic mail is not always effective compared with the method of delivering leaflets at random.

### SUMMARY OF THE INVENTION

An object of the present invention is to provide an advertisement delivery system in which advertisements can be delivered more efficiently and effectively than the conventional methods.

An advertisement delivery system according to the present invention comprises an advertisement database for storing advertising information that indicates contents that a sponsor wants to advertise for each advertisement that the sponsor requested to deliver, an interest information database for storing interest information that indicates interests of each consumer, an address database for storing network addresses of printers for printing the advertisement for each of the consumer, a receiving intention deciding portion for deciding whether or not the consumer has an intention to receive the advertisement in accordance with the interest information of the consumer and the advertising information of the advertisement, a print data transmission portion for transmitting print data for printing the advertisement to the network address of the consumer if the receiving intention deciding portion decides that the consumer has an intention to receive the advertisement, a reception record database for storing reception record information that indicates records of each consumer's reception of the advertisement, and a value calculating portion for calculating value that is given to the consumer as compensation for receiving the advertisement in accordance with the reception record information of the consumer.

Preferably, the system further comprises a delivery target database for storing delivery target information that indicates delivery targets for each advertisement, an individual information database for storing individual information of each consumer, and a delivery intention deciding portion for deciding whether or not the sponsor of the advertisement has an intention to deliver the advertisement to the consumer in accordance with the delivery target information of the advertisement and the individual information of the consumer. The print data transmission portion transmits the print data of the advertisement only to the network address of consumers who are decided to have an intention to receive the advertisement by the receiving intention deciding portion if it is decided by the delivery intention deciding portion that the sponsor of the advertisement has an intention to deliver the advertisement to the consumers.

In another embodiment, the system further comprises a contact record database for storing contact record information that indicates records of each consumer's contact with the sponsor of the advertisement by seeing printed matter of the advertisement printed by the printer. The value calculating portion calculates the value that is given to the consumer in accordance with the contact record information of the consumer.

In still another embodiment, the system further comprises a weight information storing portion for storing weight information that indicates weight of the compensation for each attribution of the advertisement. The value calculating portion calculates the value for receiving the advertisement by adding points obtained by converting a value that indicates each attribution of the advertisement in accordance with the weight information corresponding to each attribution. Alternatively, the print data transmission portion responds to a request from the printer and transmits the print data of the advertisement that is printed together with documents by the printer to the network address of the printer.

In still another embodiment, the advertisement delivery system comprises an advertisement database for storing advertising information that indicates contents that a sponsor wants to advertise for each advertisement that the sponsor requested to deliver, an interest information database for storing interest information that indicates interests of each consumer, an address database for storing network addresses of printers for printing the advertisement for each of the consumer, a desired advertisement selecting portion for selecting an advertisement that the consumer has an intention to receive among plural advertisements that describe the same service in accordance with the advertising information of the plural advertisements and the interest information of the consumer, a print data transmission portion for transmitting print data for printing the advertisement selected by the desired advertisement selecting portion to the network address of the consumer, a reception record database for storing reception record information that indicates records of each consumer's reception of the advertisement, and a value calculating portion for calculating value that is given to the consumer as compensation for receiving the advertisement in accordance with the reception record information of the consumer.

In still another embodiment, the advertisement delivery system comprises an extracting portion for extracting the price information of a service designated by the consumer for each plural advertisements designated by the consumer, a document creating portion for creating a document describing prices of the designated services that are described in the designated plural advertisements in accordance with the price information extracted by the extracting portion. Alternatively, the system comprises an extracting portion for extracting the price information of a service designated by the consumer for each of the advertisement up to now of a sponsor designated by the consumer, and a document creating portion for creating a document describing price history of the designated service of the designated sponsor in accordance with the price information extracted by the extracting portion.

In the present invention, the service includes various forms such as sales of foods, houses or home appliances, arrangement of tickets, massage, or cosmetic consult. In addition, the consumer means a customer who receives such services provided by the sponsor.

### BRIEF DESCRIPTION OF THE DRAWINGS

FIG. 1 shows an example of a structure of an advertisement delivery system according to the present invention.

FIG. 2 shows an example of a structure of an advertisement delivery apparatus.

FIGS. 3A and 3B show examples of a structure of a printer.

FIG. 4 is a diagram for explaining an example of a functional structure of an advertisement delivery apparatus.

FIG. 5 shows an example of an advertisement database.

FIG. 6 shows an example of a delivery target database.

FIG. 7 shows an example of an individual information database.

FIG. 8 shows an example of a transmission target address database.

FIG. 9 shows an example of a desired property database.

FIG. 10 shows an example of a printed leaflet.

FIG. 11 shows an example of a reception record database.

FIG. 12 shows an example of a visit record database.

FIG. 13 shows an example of an exchangeable item database.

FIG. 14 shows a flowchart for explaining an example of process of the advertisement delivery apparatus.

FIG. 15 shows an example of a structure of an advertisement delivery system.

FIG. 16 is a diagram for explaining an example of a functional structure of an advertisement delivery apparatus.

FIG. 17 shows an example of an advertisement database.

FIG. 18 shows an example of a delivery target database.

FIG. 19 shows an example of a desired product database.

FIG. 20 shows an example of a structure of an advertisement delivery system.

FIG. 21 is a diagram for explaining an example of a functional structure of an advertisement delivery apparatus.

FIG. 22 shows an example of an advertisement database.

FIG. 23 shows an example of an individual information database.

FIG. 24 shows an example of a desired product database.

FIG. 25 shows an example of a printed matter of a document containing an advertisement.

FIG. 26 is a diagram for explaining an example of a functional structure of an advertisement delivery apparatus.

FIG. 27 shows an example of an advertisement database.

FIGS. 28A and 28B show examples of a document that describes a comparison table.

FIG. 29 is a diagram for explaining an example of a functional structure of an advertisement delivery apparatus.

FIG. 30 is a diagram for explaining an example of a structure of a printer and a personal computer.

FIG. 31 is a diagram for explaining an example of a method for calculating the value points.

### DESCRIPTION OF THE PREFERRED EMBODIMENTS

Hereinafter, the present invention will be explained more in detail with reference to embodiments and drawings.

[First Embodiment]

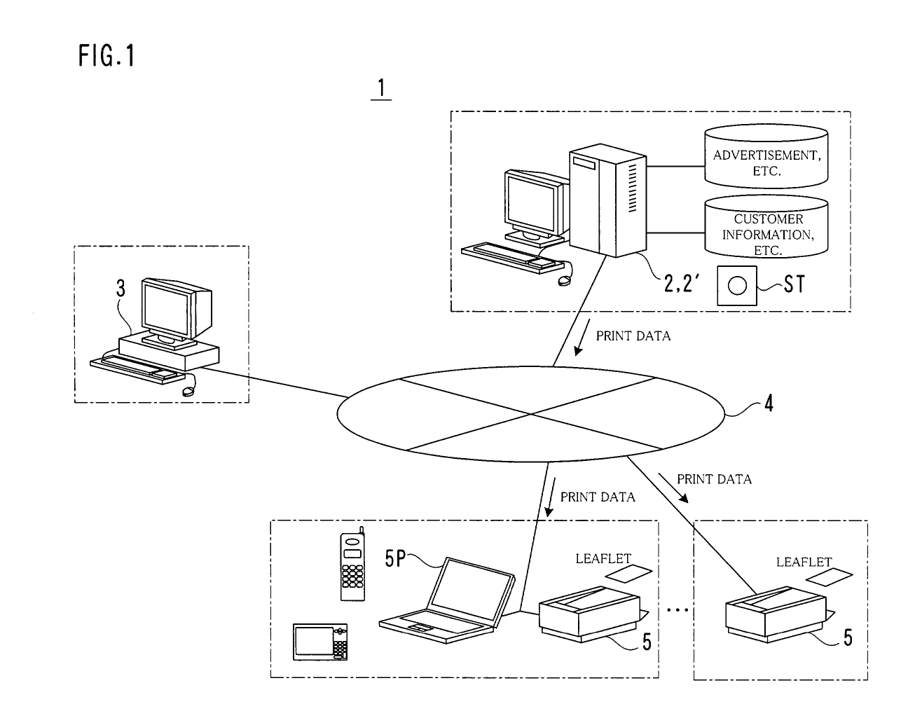

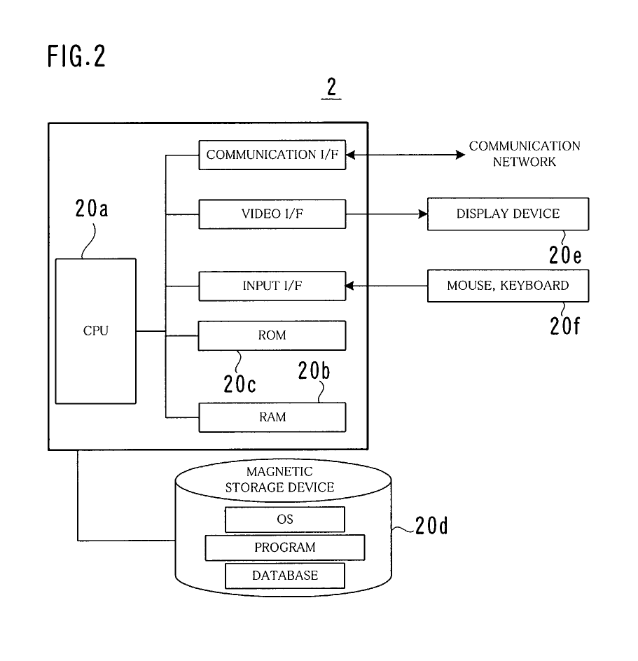

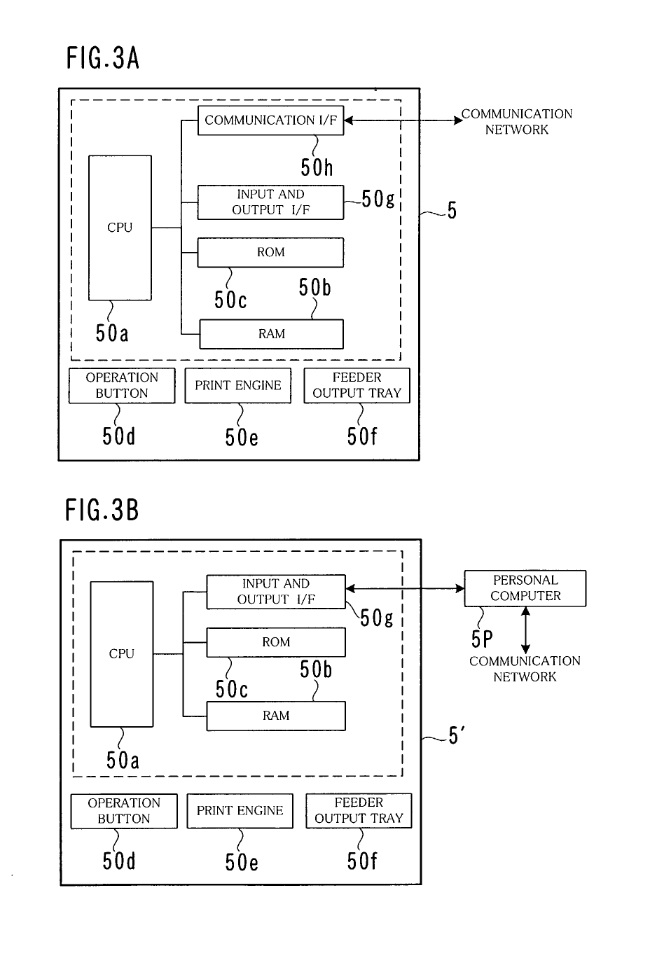

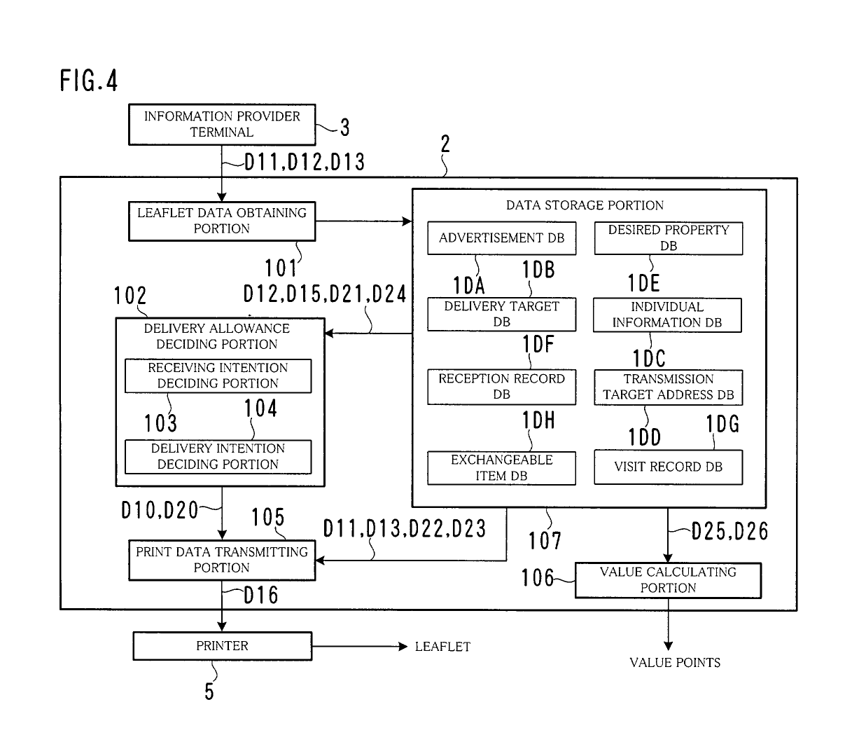

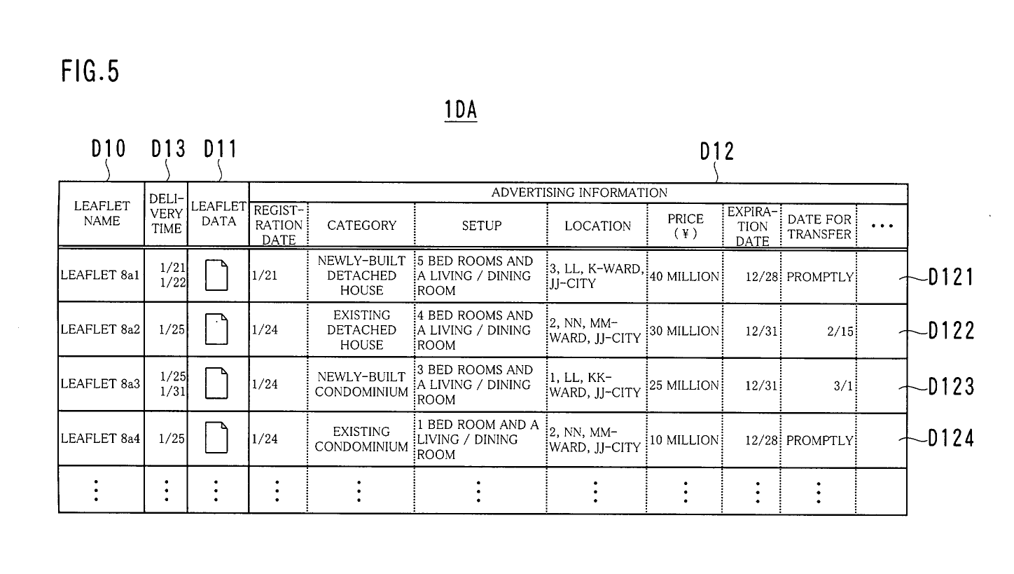

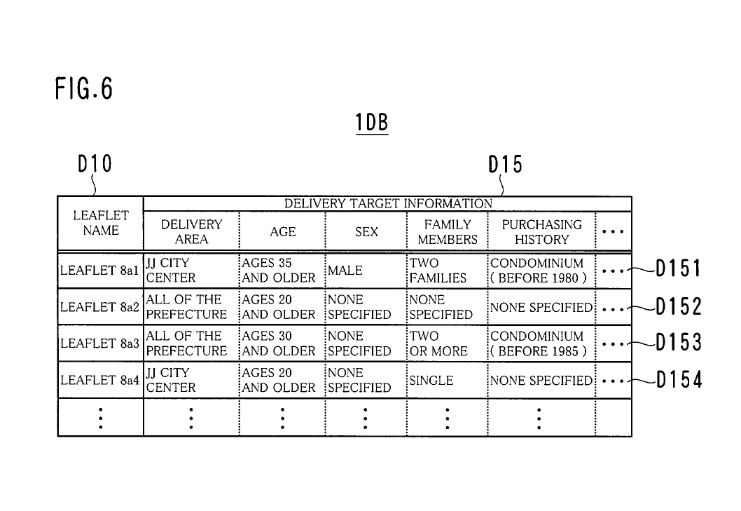

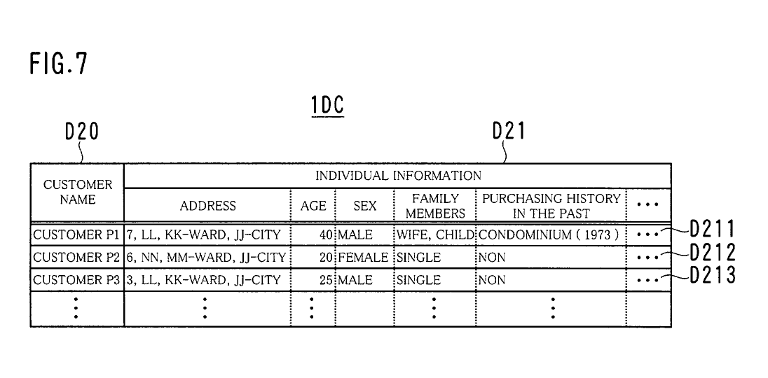

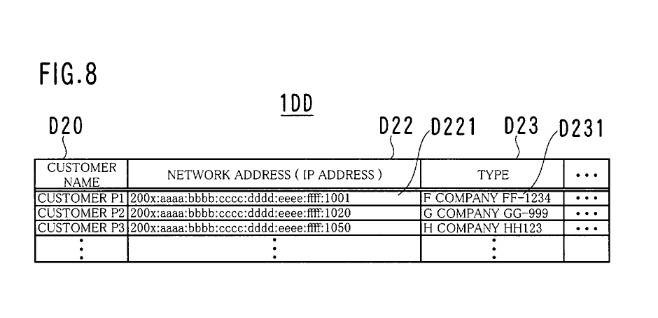

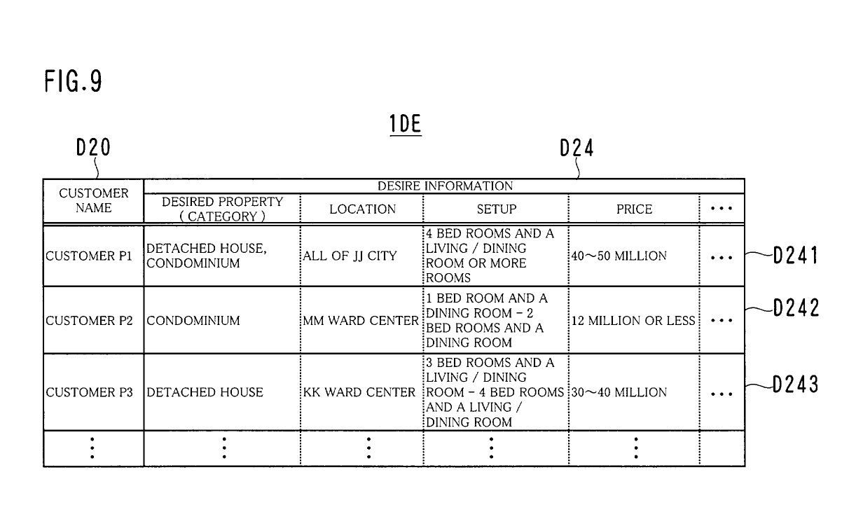

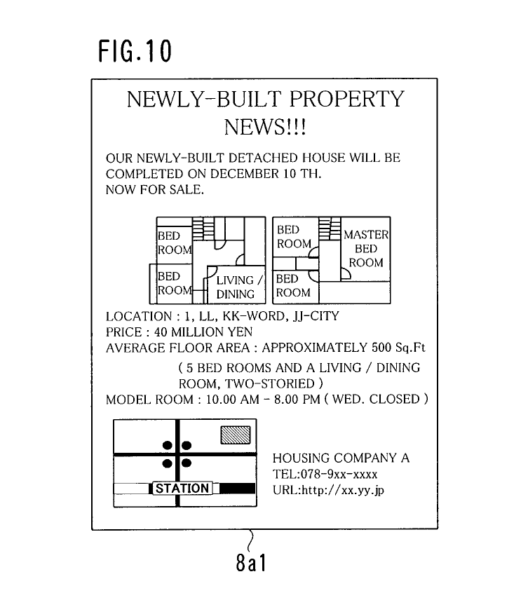

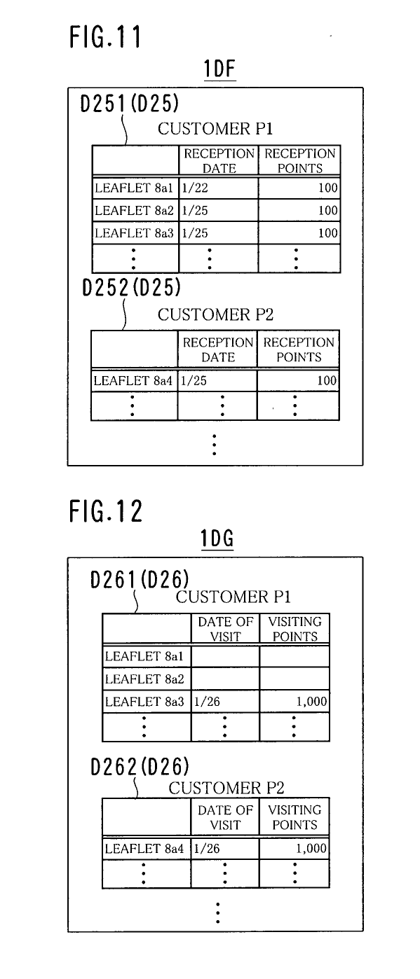

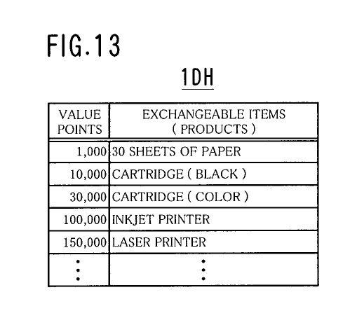

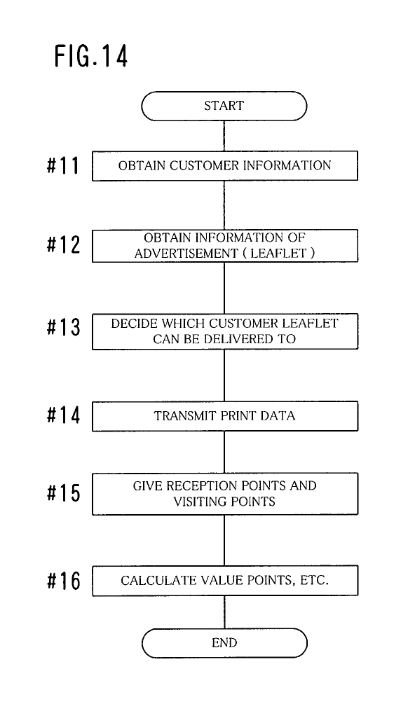

FIG. 1 shows an example of a structure of an advertisement delivery system 1 according to the present invention. FIG. 2 shows an example of a structure of an advertisement delivery apparatus 2. FIGS. 3A and 3B show examples of a structure of a printer 5. FIG. 4 is a diagram for explaining an example of a functional structure of an advertisement delivery apparatus 2. FIG. 5 shows an example of an advertisement database 1DA. FIG. 6 shows an example of a delivery target database 1DB. FIG. 7 shows an example of an individual information database 1DC. FIG. 8 shows an example of a transmission target address database 1DD. FIG. 9 shows an example of a desired property database 1DE. FIG. 10 shows an example of a printed leaflet 8a1. FIG. 11 shows an example of a reception record database 1DF. FIG. 12 shows an example of a visit record database 1DG. FIG. 13 shows an example of an exchangeable item database 1DH. FIG. 14 shows a flowchart for explaining an example of process of the advertisement delivery apparatus 2.

As shown in FIG. 1, an advertisement delivery system 1 according to the present invention comprises an advertisement delivery apparatus 2, an information provider terminal 3 and a communication network 4. This advertisement delivery system 1 delivers advertisements of houses and condominiums that a housing company A deals with to each home. Each home is provided with a printer 5 for printing an advertisement of the housing company A as a leaflet shown in FIG. 10. The communication network 4 can be the Internet, an intranet, a public telephone network or a private line. As communication protocols, TCP/IP and HTTP (Hypertext Transfer Protocol) that is an upper class protocol of TCP/IP, and IPP (Internet Printing Protocol) are used.

The information provider terminal 3 is installed in the housing company A for entering information such as prices, locations, setups of properties that are handled by the housing company A. The information provider terminal 3 is connected to a device such as an image scanner or a digital camera, so as to obtain an image such as a picture or an illustration. Furthermore, an application program for DTP (Desktop Publishing) is installed in a magnetic storage device of the information provider terminal 3, so that a layout of a headline, an advertisement text and an image such as a picture or an illustration can be created and that image data of a leaflet can be produced. The information provider terminal 3 can be a personal computer or a workstation.

The advertisement delivery apparatus 2 performs a process for managing information of properties obtained from the information provider terminal 3, image data of leaflets and individual information of customers of the housing company A, and for delivering print data for printing a leaflet to the printer 5 installed at home of the customer. The advertisement delivery apparatus 2 comprises a CPU 20a, a RAM 20b, a ROM 20c, a magnetic storage device 20d, a display device 20e and an input device 20f such as a mouse or a keyboard as shown in FIG. 2.

The magnetic storage device 20d stores an operating system (OS) and various programs and data for realizing functions that will be explained later. The programs are installed from a recording medium ST such as a CD-ROM, a MO or a DVD-ROM into the magnetic storage device 20d. The programs and the data are loaded to the RAM 20b and executed by the CPU 20a. The advertisement delivery apparatus 2 can be a UNIX (a registered trademark) server, a workstation or a personal computer. The advertisement delivery apparatus 2 can be administered by the housing company A or by an advertisement agent or an internet service provider in lieu of the housing company A.

As shown in FIG. 3A, the printer 5 comprises a CPU 50a, a RAM 50b, a ROM 50c, an operation button 50d, a print engine 50e, a feeder output tray 50f, an I/O interface 50g and a communication interface 50h. The ROM 50c stores various programs and data for performing a process that will be explained later.

The printer 5 supports IPP. Therefore, print data that the advertisement delivery apparatus 2 transmits are delivered to the printer 5 through routers or firewalls placed inside and outside the advertisement delivery system 1. The print data delivered to the printer 5 are stored in the RAM 50b, and a print process is performed in accordance with the print data.

Alternatively, as shown in FIG. 3B, the printer 5′ can be connected to a personal computer 5P via the I/O interface 50g, so that the printer 5′ and the personal computer 5P make up a set of printer for receiving an advertisement. In this case, an application program for controlling the printer 5′ is installed in the personal computer 5P. Thus, a user of the printer 5′ can operate the printer 5′ easily by using a keyboard or a mouse of the personal computer 5P instead of the operation button 50d. In addition, since the communication process is performed by the personal computer 5P, process load of the printer 5′ can be reduced.

According to this structure, functions including a leaflet data obtaining portion 101, a delivery allowance deciding portion 102, a print data transmitting portion 105, a value calculating portion 106 and a data storage portion 107 are realized in the advertisement delivery apparatus 2 as shown in FIG. 4.

The data storage portion 107 manages databases including an advertisement database 1DA, a delivery target database 1DB, an individual information database 1DC, a transmission target address database 1DD, a desired property database 1DE, a reception record database 1DF, a visit record database 1DG and an exchangeable item database 1DH.

As shown in FIG. 5, the advertisement database 1DA stores leaflet data D11, advertising information D12 and delivery time information D13 in connection with a leaflet name D10. The leaflet data D11 are image data of the leaflet generated by a DTP application program or others of the information provider terminal 3. The delivery time information D13 indicates a time when the leaflet is delivered. The advertising information D12 indicates items of an advertisement that a sponsor want to advertise to customers by delivering the leaflet. For example, the advertising information D12 includes a category, a setup, location, a price of the property to be described on the leaflet, a period for sale (or expiration date of the leaflet), the time (and the date) for transfer and the registration date of the information. The advertising information D12 and the delivery time information D13 are entered by using the information provider terminal 3.

The delivery target database 1DB stores delivery target information D15 for each leaflet 8a1, 8a2, . . . as shown in FIG. 6. The delivery target information D15 indicates a condition of customers to be a target of delivery of the leaflet. For example, according to delivery target information D151, a delivery target of the leaflet 8a1 satisfies a part or all of the conditions that he or she lives in JJ city, more than or equal to 35 years old, a male, has two-generation family, and has bought a condominium before 1980. It will be explained later which condition is to be satisfied for delivering the leaflet 8a1.

The individual information database 1DC stores individual information D21 including an address, age, sex, family members and purchasing history of each customer in connection with the customer's name D20 as shown in FIG. 7.

The transmission target address database 1DD stores a network address D22 and type information D23 of the printer 5 that the customer uses for printing a leaflet in connection with the customer's name D20 as shown in FIG. 8. As the network address D22, an IP address of the IP version 6 (IPv6) is used. The type information D23 indicates a manufacturer and a type name of the printer 5.

The desired property database 1DE stores desire information D24 including a category, location, setup and a price of a property that a customer has an interest or desire to purchase in connection with the customer's name D20 as shown in FIG. 9.

The individual information D21, the network address D22, the type information D23 and the desire information D24 are entered by using the personal computer 5P at user's home. For example, a WWW browser of a personal computer 5P displays a Web page, through which information is entered and transmitted to the advertisement delivery apparatus 2 so as to be registered in each database. Alternatively, the advertisement delivery apparatus 2 or the information provider terminal 3 displays a similar Web page, and a customer who visits the housing company A may input the information by himself. Alternatively, a registration form is delivered to a customer, who may fill in the form and return the form to the housing company A for registration. In this case, a staff member of the housing company A may input the items written in the form into the advertisement delivery apparatus 2 or the information provider terminal 3 for registering in each database. Therefore, even if a customer has no information terminal such as a personal computer 5P at home, such information can be registered.

The delivery allowance deciding portion 102 comprises a receiving intention deciding portion 103 and a delivery intention deciding portion 104, so as to decide whether or not an advertisement (a leaflet) is delivered to a customer. The receiving intention deciding portion 103 decides whether or not the consumer has an intention to receive the leaflet that is about to be delivered. The delivery intention deciding portion 104 decides whether or not the housing company A that is a sponsor has an intention to deliver the leaflet to each customer. If it is decided that each of the customer and the sponsor has an intention by the receiving intention deciding portion 103 and the delivery intention deciding portion 104, the delivery allowance deciding portion 102 decides that the leaflet can be delivered to the customer. Otherwise, the delivery allowance deciding portion 102 decides not to deliver. For example, the following process is performed for deciding whether the leaflet 8a1 is to be delivered or not.

The receiving intention deciding portion 103 decides whether or not the customers P1, P2, . . . have an intention to receive the leaflet 8a1 by comparing the desire information D24 (D241, D242, . . . ) of each customer shown in FIG. 9 with the advertising information D121 of the leaflet 8a1 shown in FIG. 5.

For example, comparing the desire information D241 of the customer P1 with the advertising information D121 of the leaflet 8a1, intentions of the customer P1 and property features of the leaflet 8a1 are identical concerning four items including a category, setup, location and a price. In the same way, three items are identical in the case of the customer P3, while no item is identical in the case of the customer P2. In accordance with this comparison and predetermined rules, the customer's intention is decided. For example, it is supposed that a rule is set that the customer has an intention to receive if the number of items that are identical is equal to or more than a predetermined value (e.g., two). Then, it is decided that the customers P1 and P3 have an intention to receive the leaflet 8a1, while the customer P2 has no intention to receive.

The delivery intention deciding portion 104 decides which customer among the customers P1, P3 . . . who have been decided to have an intention to receive the leaflet 8a1 by the receiving intention deciding portion 103 the sponsor has an intention to deliver the leaflet 8a1 to. Such decision is performed by comparing the individual information D21 (D211, D213, . . . ) of each customer shown in FIG. 7 with the delivery target information D151 of the leaflet 8a1 shown in FIG. 6.

For example, comparing the individual information D211 of the customer P1 with the delivery target information D151 of the leaflet 8a1 , four items including an address, age, sex, and properties that have been bought in the past (the purchasing history) of customer P1 are identical to the intention of the sponsor. Then, in the same way as the case of the receiving intention deciding portion 103, it is decided that the sponsor has an intention to deliver the leaflet 8a1 to the customer P1 if the number of the identical items is equal to or more than a predetermined value (e.g., three). According to this rule, since there are two items in the case of the customer P3, the sponsor is decided not to have an intention to deliver to the customer P3. In this way, the receiving intention deciding portion 103 and the delivery intention deciding portion 104 decide that the leaflet 8a1 can be delivered to the customer P1, while it cannot be delivered to the customers P2 and P3.

In the above-mentioned example, the decision whether the customer has an intention to receive the leaflet is performed before the decision whether the sponsor has an intention to deliver. However the two decisions can be performed in a retrograde order. Furthermore, the condition for the decisions can be modified in accordance with a policy of the housing company A, for example. It is possible to decide that the delivery is possible if the desired price of the customer and the price of the property are identical regardless of the number of other identical items. Alternatively, it is possible to decide that the delivery is not possible if category is not identical regardless of the number of other identical items.

The print data transmitting portion 105 transmits print data D16 for printing the leaflet to the printer 5 of a customer who was decided that the leaflet can be delivered by the delivery allowance deciding portion 102. For example, in the case of the above-mentioned leaflet 8a1, the print data D16 are transmitted to the printer 5 of the customer P1. The transmission process is performed as follows.

First, type information D231 and a network address D221 of the printer 5 of the customer P1 who is a transmission target are searched from the transmission target address database 1DD shown in FIG. 8. The leaflet data D11 of the leaflet 8a1 are obtained from the advertisement database 1DA and are converted into a print job that can be printed by a printer of a type indicated in the type information D231. Then, the converted print job is transmitted as the print data D16 to the IP address indicated by the network address D221. The print data D16 are received by the printer 5, which prints the leaflet 8a1 in accordance with the print data D16 as shown in FIG. 10.

The transmission of the print data D16 is performed at a predetermined time on a predetermined date indicated in the delivery time information D13 shown in FIG. 5. For example, in the case of the leaflet 8a1, on the basis of the delivery time information D131, the print data D16 are transmitted at a predetermined time (e.g., seven in the morning) on January 21. If the delivery time information D13 is “promptly”, it is transmitted promptly when the advertisement (the leaflet) is registered from the information provider terminal 3 to the advertisement database 1DA. The delivery time information D13 can include times and minutes. Plural setting can be performed for one leaflet.

The reception record database 1DF of the data storage portion 107 stores reception record information D25 (D251, D252, . . . ) concerning the record that the customers P1, P2, . . . have received leaflets in the past as shown in FIG. 11. For example, the reception record information D251 indicates that the customer P1 has received the leaflet 8a1, 8a2 and 8a3 on January 22, 25 and 25, respectively. Every time when receiving a leaflet, predetermined points (e.g., 100 points) are given as reception points.

The reception points are written into the reception record information D25 of the transmission target customer every time when the print data D16 are transmitted from the print data transmitting portion 105 to the printer 5. Alternatively, the reception points are written when receiving a notice of completion of printing from the printer 5 after the print data D16 are transmitted. The reception points that are given to the customer may be modified depending on contents of the advertisement. For example, it may be altered depending on the price of the property in such a way that the reception points of the leaflet 8a1 shown in FIG. 5 is 400 points, and the reception points of the leaflet 8a2 is 300 points.

The visit record database 1DG stores visit record information D26 (D261, D262, . . . ) concerning the record that each of the customers P1 and P2, . . . visits the housing company A bringing a leaflet printed by the printer 5 as shown in FIG. 12. For example, the visit record information D261 indicates that the customer P1 came on January 26 bringing the leaflet 8a3. Predetermined visiting points (e.g., 1000 points) are added to the reception record information D25 of the customer every visit.

The visiting points are added to the visit record information D26 as follows. After confirming that the customer brought a leaflet, a staff member of the housing company A operates the information provider terminal 3 so as to enter the customer's name, date of visit and the leaflet name. The entered information is transmitted to the advertisement delivery apparatus 2. Then, the data storage portion 107 writes predetermined visiting points in the visit record information D26 of the customer. It is possible to give further points depending on various events such as an agreement.

The value calculating portion 106 calculates value points given to a customer as compensation for receiving a leaflet. The customer can receive goods such as consumable products of the printer 5 from the housing company A for the given value points.

The calculation of the value points is performed as follows. For example, in the case of the customer P1, a total sum of the reception points included in the reception record information D251 of the reception record database 1DF shown in FIG. 11 is calculated first. In the same way, a total sum of the visiting points included in the visit record information D261 of the visit record database 1DG shown in FIG. 12 is calculated. Then, these points are summed up to make the value points. Therefore, the customer P1 is given 1,300 points as the value points that is a total sum of the reception points (300 points) and the visiting points (1,000 points).

The customer can receive any products from the products listed in the exchangeable item database 1DH shown in FIG. 13 in accordance with his/her value points. The customer may select a desired product from a web page for selecting products that is displayed in the WWW browser of the personal computer 5P. Then, information indicating the customer's name and the selected product name is transmitted to the information provider terminal 3 through the advertisement delivery apparatus 2. A staff member of the housing company A may send the product to the customer's address by mail in accordance with the received information. The points that were exchanged for the product were deleted from the reception record database 1DF or the visit record database 1DG. An exchange rate between the product in the exchangeable item database 1DH and the value points is set to an extent that the customer's cost for printing leaflets can be compensated.

Alternatively, it is possible that when visiting the housing company A, the customer exchanges the value points for a product. In this case, the information provider terminal 3 may display the web page for selecting a product, so that a customer can select a product. Preferably, an expiration date is set for the reception points and/or the visiting points, so that the points are removed from the database if they are not used before the expiration date.

Next, the process of the advertisement delivery apparatus 2 will be explained with reference to a flowchart shown in FIG. 14. As a preparation for delivering an advertisement (a leaflet), information of a customer including individual information, a network address of the printer 5 and a desired property are registered in advance as shown in FIGS. 7, 8 and 9 (#11). When the information is entered from the personal computer 5P of the customer, each database is updated. Image data of a leaflet to be delivered, information about contents of the advertisement, and information about delivery target of the leaflet are obtained and are registered in each database as shown in FIGS. 5 and 6 (#12).

It is decided which customer the obtained leaflet can be delivered to (#13), and the print data D16 of the leaflet are transmitted to the printer 5 of the customer who was decided to be delivered in the form corresponding to each type of the printer 5 (#14). After transmitting the print data D16 or receiving a notice of print completion from the printer 5, predetermined reception points are given to the customer (#15). Furthermore, visiting points are given to a customer who brought a printed leaflet. Then, if the customer requested, the value points are calculated in accordance with the reception points and the visiting points, so that the process for exchanging the value points for a product such as a consumable product is performed (#16).

According to this embodiment, the housing company A can deliver a leaflet to a customer efficiently and can reduce a cost for advertisement. Since the leaflet is generated by arranging characters and images, it can be seen easily than advertisement by electronic mail and can give an impact to a customer. Since consumable products of the printer are provided at no charge for reception points, the customer can receive a leaflet without worrying about a running cost for the printer.

In addition, visiting points are given to a customer who brought the leaflet. Thus, the housing company A promotes customer's visit to the housing company, so that sales promotion of properties that is an object of the delivery of leaflets can be realized. In addition, the housing company A can know effects of the delivery of leaflets.

An advertisement agent or an internet service provider that administrates the advertisement delivery apparatus 2 collects advertisement fee from the housing company A as an agent fee for delivering leaflets. Some of the agent fee is used as payment for consumable products of the printer 5 of customers (delivery targets). According to the advertisement delivery system 1 of this embodiment, leaflets are delivered via a network. Therefore, as distinct from the case where paper leaflets are delivered, a cost for delivery is not so increased even if the number of delivered leaflets increases because labor costs scarcely increase. Therefore, the advertisement agent can increase profits by increasing the number of leaflets to be delivered. In addition, the amount that are used for consumable products that are given to customer can be increased for the increase of profits, so the service to the delivery targets can be improved by e.g., giving printers at no charge. Thus, the number of delivery targets can be increased.

Although the visiting points are given when a customer came to the housing company A, it is possible to give when a customer had access to the web page of the housing company A after viewing the URL (Uniform Resource Locators) described on the leaflet or when a customer made a telephone inquiry or when a customer made a request for documents of a property.

[Second Embodiment]

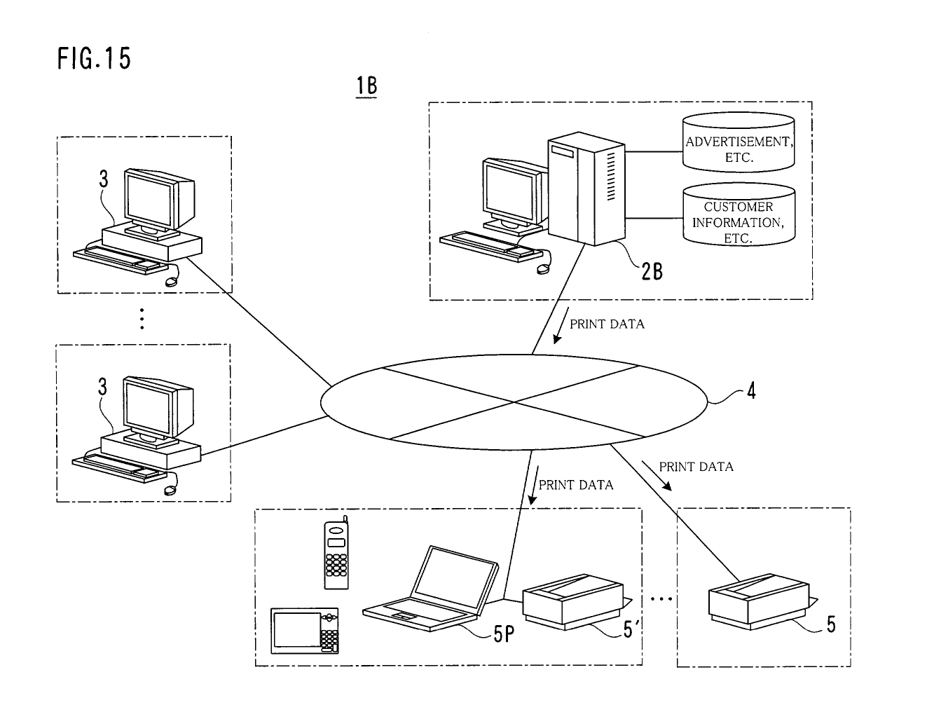

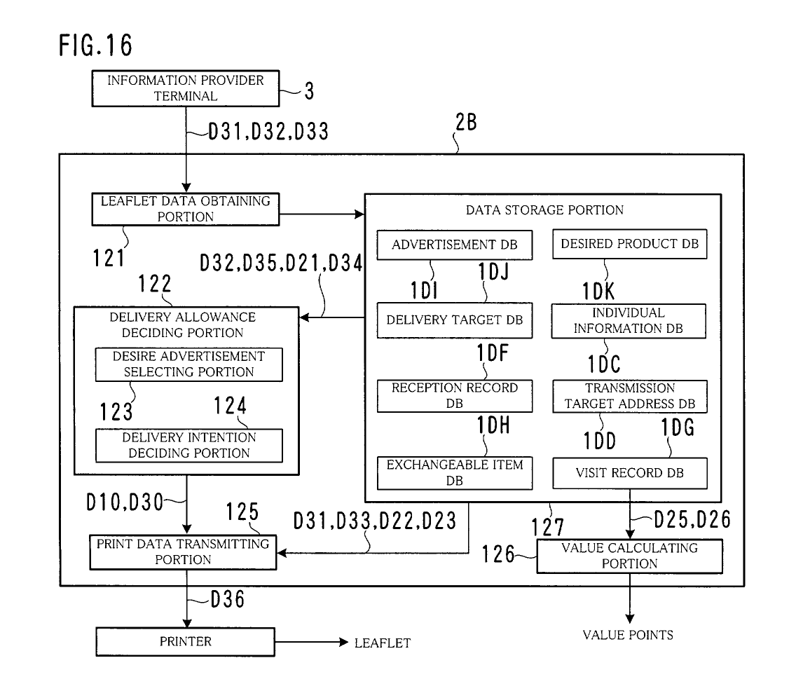

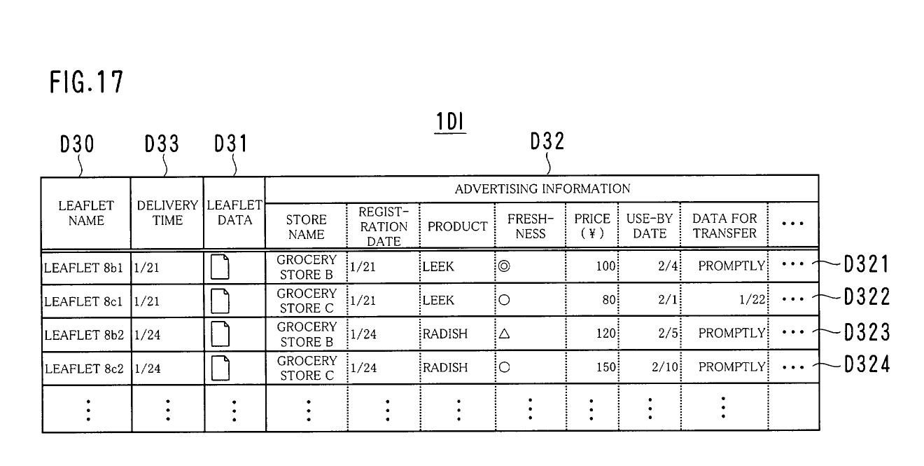

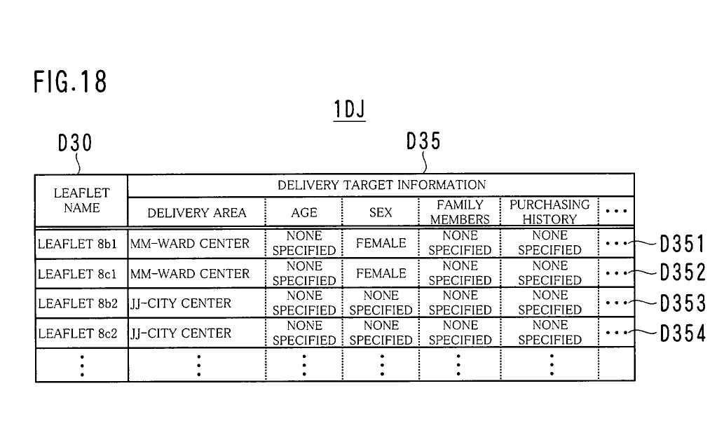

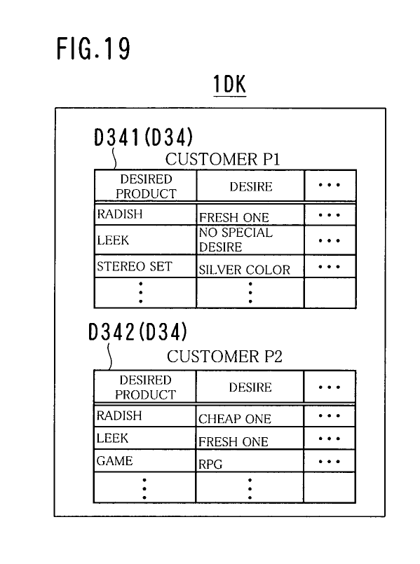

FIG. 15 shows an example of a structure of an advertisement delivery system 1B. FIG. 16 is a diagram for explaining an example of a functional structure of an advertisement delivery apparatus 2B. FIG. 17 shows an example of an advertisement database 1DI. FIG. 18 shows an example of a delivery target database 1DJ. FIG. 19 shows an example of a desired product database 1DK.

The advertisement delivery system 1 of the first embodiment delivers an advertisement (a leaflet) of one company. In this embodiment shown in FIG. 15, the advertisement delivery system 1B is installed in a shopping mall α that comprises various stores including a grocery store, an electronics store and a toy store and delivers leaflets of the stores. The advertisement delivery system 1B comprises an advertisement delivery apparatus 2B, an information provider terminal 3 and a communication network 4. The advertisement delivery system 1B is administrated with advertisement cost that is disbursed by the stores.

Each home is provided with a printer 5 or a set of printer 5′ and a personal computer 5P in the same way as the first embodiment. In addition, at least one information provider terminal 3 is installed in each store of the shopping mall α.

A hardware structure and a functional structure of the advertisement delivery apparatus 2B are basically the same as the case of the advertisement delivery apparatus 2 shown in FIG. 1. However, advertisements of the stores of the shopping mall α are handled in this embodiment, so a structure of a database stored in a data storage portion 127 is a little different from the advertisement delivery apparatus 2 as shown in FIG. 16.

The advertisement database 1DI of the data storage portion 127 stores leaflet data D31, advertising information D32 and delivery time information D33 of a leaflet that each store delivers to a customer in relationship with the leaflet name D30 as show in FIG. 17 and in the same way as the advertisement database 1DA shown in FIG. 5. The leaflet name D30 or the delivery time information D33 has a role similar to the leaflet name D10 or the delivery time information D13 shown in FIG. 5, respectively. However, the advertising information D32 comprises items different from the advertising information D12 so that it is adapted to contents of the advertisement of each store. For example, each mark in “freshness” of the advertising information D32 indicates a degree of freshness of a product; a double circle, a circle or a triangle is added in the descending order of the degree of freshness.

The delivery target database 1DJ stores delivery target information D35 that indicates a delivery target that the sponsor desires as shown in FIG. 18 and in the same way as the delivery target database 1DB shown in FIG. 6. For example, delivery target information D353 indicates that the grocery store B desires to deliver a leaflet 8b2 to customers in JJ city.

The desired product database 1DK stores desired information D34 (D341, D342, . . . ) indicating products in which the customers P1, P2, . . . have an interest and desires when the products are purchased as shown in FIG. 19. For example, the desired information D341 indicates that the customer P1 has an interest in products including a radish, a leek and a stereo set, desires a fresh one when buying a radish, and desires silver color when buying a stereo set.

A leaflet data obtaining portion 121 obtains the leaflet data D31 from the information provider terminal 3 in each store including the grocery stores B and C similarly to the leaflet data obtaining portion 101 shown in FIG. 4.

A delivery allowance deciding portion 122 comprises a desire advertisement selecting portion 123 and a delivery intention deciding portion 124, and decides whether or not to deliver a leaflet to a customer similarly to the delivery allowance deciding portion 102. However, in this embodiment, plural stores may deliver leaflets describing the same product at the same time. In that case, the following process is performed.

For example, it is supposed that as shown in FIG. 17 the grocery stores B and C are about to deliver the leaflets 8b2 and 8c2 of a radish to a customer on the same day, January 24. First, the delivery intention deciding portion 124 decides whether or not the grocery stores B and C that are sponsors desire to deliver the leaflets 8b2 and 8c2 to the customers P1, P2, . . . . This decision is performed in accordance with individual information D21 of the customers shown in FIG. 7 and delivery target information D353 and D354 of the leaflets 8b2 and 8c2 shown in FIG. 18 in the same way as the case of the delivery intention deciding portion 104 shown in FIG. 4. A rule for decision of being desired or not may be set for each sponsor.

It is supposed that the delivery intention deciding portion 124 decides that both the leaflets 8b2 and 8c2 are desired to be delivered to the customers P1 and P2. Next, the desire advertisement selecting portion 123 decides which one of the leaflets 8b2 and 8c2 the customers P1 and P2 desire to receive.

For example, in the case of the customer P1, it is decided from the desired information D341 that a fresh radish is desired. Then, the advertising information D323 and D324 of the leaflets 8b2 and 8c2 shown in FIG. 17 are compared to each other, and it is decided that the customer P1 desires to receive the leaflet 8c2 describing a fresher radish. Similarly, in the case of the customer P2, the leaflet 8b2 describing a cheaper radish is selected. If there is no designation about freshness and a price, both the leaflets are selected.

In this way, the delivery allowance deciding portion 122 decides that the leaflet 8b2 can be delivered to the customer P2, while the leaflet 8c2 can be delivered to the customer P1. Then, a print data transmitting portion 125 generates print data D36 of each leaflet in the same way as the print data transmitting portion 105 shown in FIG. 4, and transmits the print data D36 to the printer 5 of the customer who was decided to be delivered.

The reception points and the visiting points are also accumulated in the reception record database 1DF and the visit record database 1DG in the same way as the first embodiment. Then, a value that is given to the customer as compensation for receiving the leaflet is calculated as the value points by a value calculating portion 126. The customer can select and receive a desired product from the exchangeable item database 1DH in accordance with his/her value points. It is possible that the reception points and the visiting points are calculated for each store, and the product of the value can be received only from the store that issued the points. Alternatively, the reception points and the visiting points may be common to all stores in the shopping mall α, and the points are handled as service points of the entire shopping mall α. It is possible that the reception points and the visiting points can be used together with shopping points in the shopping mall α.

This embodiment enables to deliver a leaflet that is more suitable for desire of a customer when there are plural leaflets describing the same product. Thus, delivery of leaflets can be performed more efficiently. Though both the leaflets are delivered if there is no special desire, it is possible in this case for the customer to compare pictures or prices of the product in the two leaflets with each other so as to decide the store to buy the product.

The grocery stores B and C that handle the same product can know the effect of delivering the leaflet by referring the number of visitors and the sales of the product after delivering the leaflet. In addition, it can be helpful to decide the price of the price in the future.

[Third Embodiment]

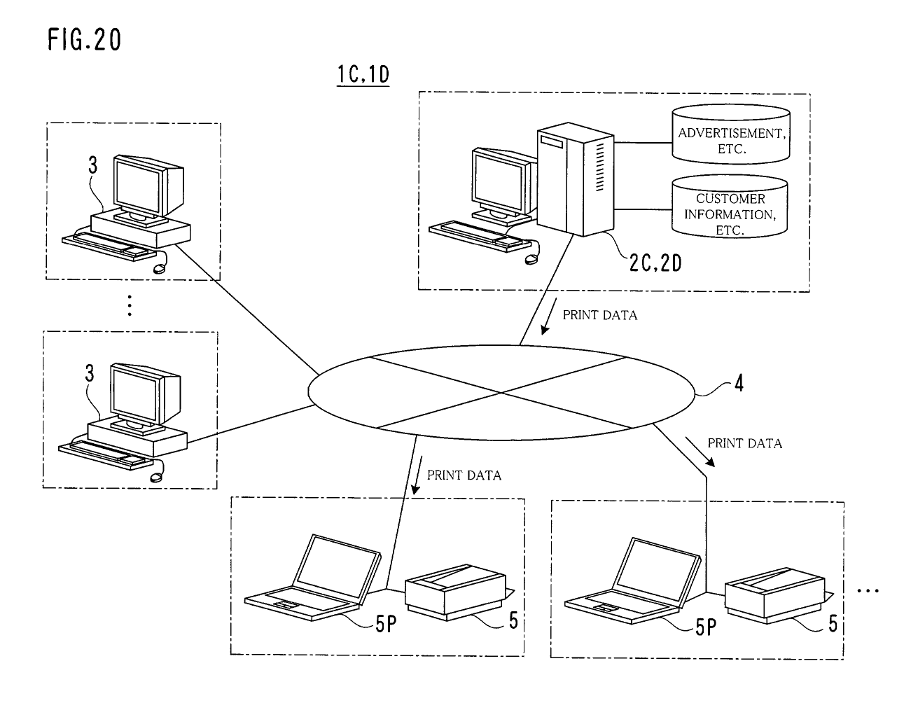

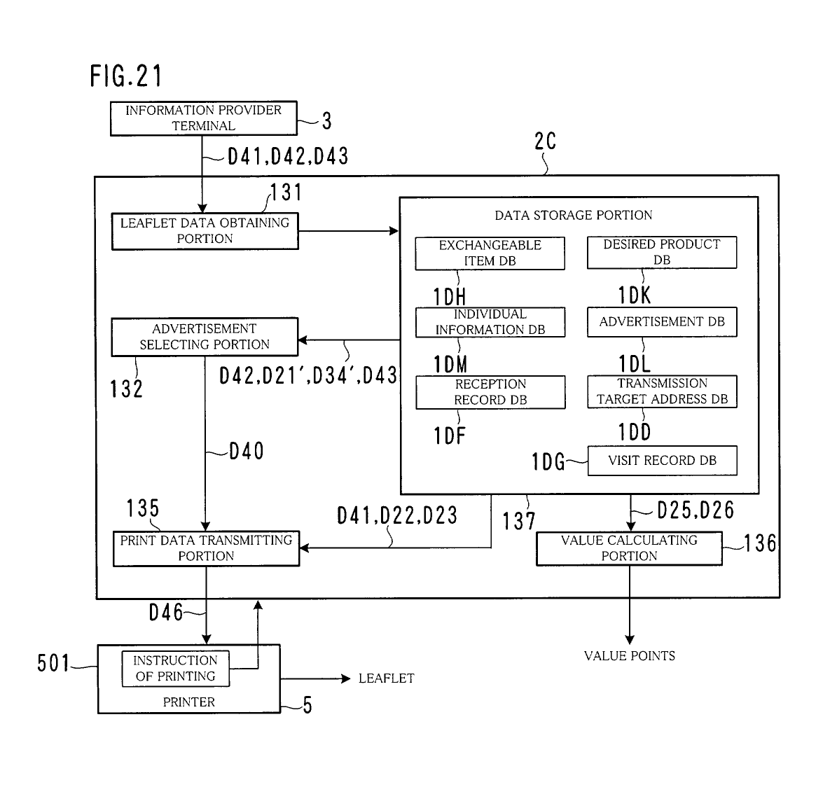

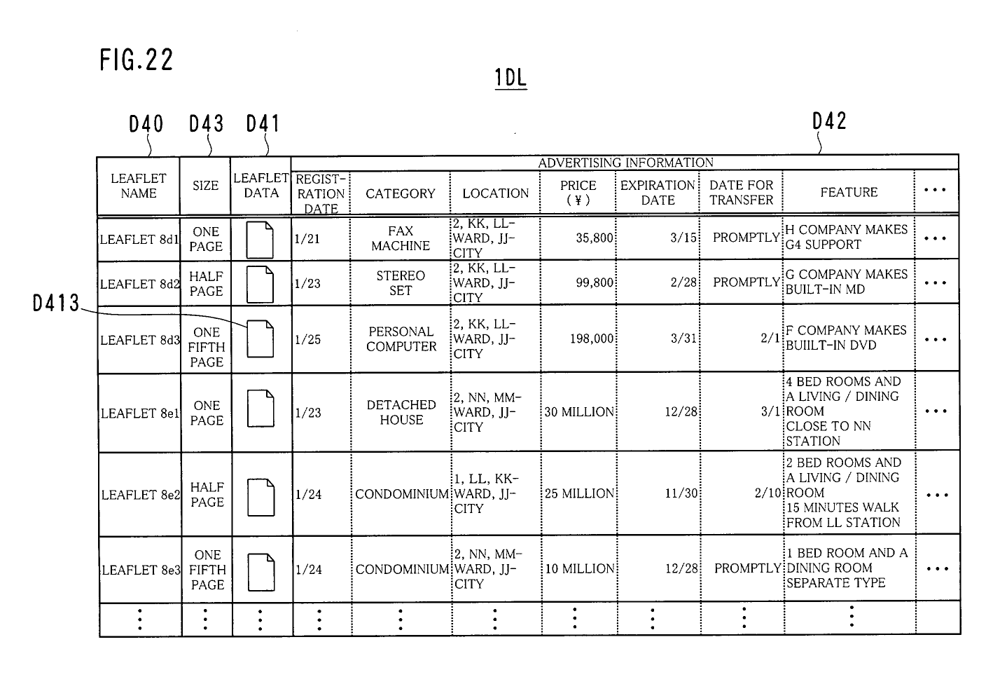

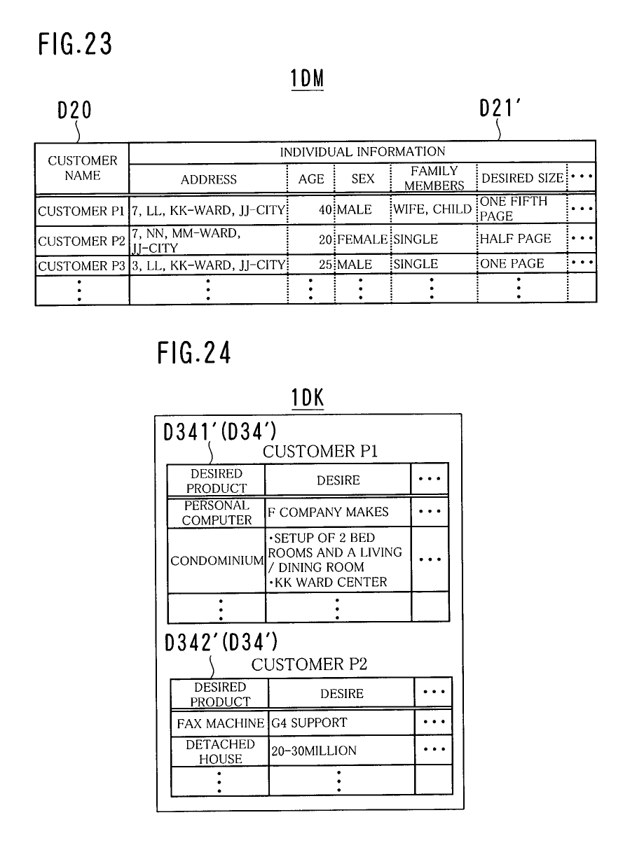

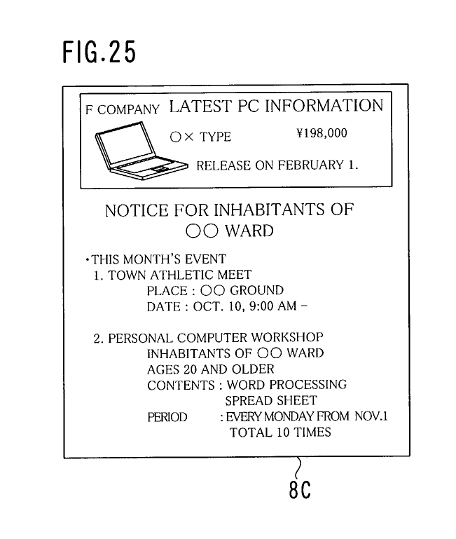

FIG. 20 shows an example of a structure of an advertisement delivery system 1C or 1D. FIG. 21 is a diagram for explaining an example of a functional structure of an advertisement delivery apparatus 2C. FIG. 22 shows an example of an advertisement database 1DL. FIG. 23 shows an example of an individual information database 1DM. FIG. 24 shows an example of a desired product database 1DK. FIG. 25 shows an example of a printed matter 8C of a document containing an advertisement.

In the first embodiment and the second embodiment, a leaflet is delivered at the timing designated by a sponsor. In the third embodiment, data of the advertisement is delivered when the printer 5 pints a document, so that the advertisement is contained in a part of the document (see FIG. 25).

The advertisement delivery system 1C comprises an advertisement delivery apparatus 2C, an information provider terminal 3 and a communication network 4 as shown in FIG. 20. The advertisement delivery system 1C performs a process for delivering advertisements (leaflets) of plural companies or stores to customers at homes. At least one information provider terminal 3 is installed in each company or store. A set of a personal computer 5P and a printer 5 is installed in each home.

A hardware structure and a functional structure of the advertisement delivery apparatus 2C are basically the same as the case of the advertisement delivery apparatus 2B shown in FIG. 15. Hereinafter, functions that are different from the case of the advertisement delivery apparatus 2B will be explained with reference to FIG. 21.

The advertisement database 1DL of the data storage portion 137 stores leaflet data D41, advertising information D42 and size information D43 in relationship with a leaflet name D40 as shown in FIG. 22. The leaflet data D41 and the advertising information D42 are generated or entered by the information provider terminal 3. The size information D43 indicates a ratio of a part of the advertisement in one page. In this embodiment, there are three kinds of sizes that are one page, a half page and one fifth page.

Furthermore, the data storage portion 137 includes databases including an individual information database 1DM, a transmission target address database 1DD, a desired product database 1DK, a reception record database 1DF, a visit record database 1DG and an exchangeable item database 1DH. However, as shown in FIG. 23, the individual information D21′ of the individual information database 1DM includes information about the advertisement size that the customer desires to receive (a desired size). Furthermore, the desired product database 1DK stores desired information D34′ (D341′, D342′, . . . ) corresponding to sponsors of this embodiment as shown in FIG. 24.

An advertisement selecting portion 132 selects one of the advertisements to be delivered to the customer from the advertisement database 1DL shown in FIG. 22. Such selection is performed in the following procedure.

For example, it is supposed that the customer P1 is about to print a document created by the personal computer 5P. The advertisement requesting portion 501 of the printer 5 requests the advertisement delivery apparatus 2C to transmit data for printing an advertisement when receiving an instruction for printing a document from the personal computer 5P.

Responding to the request from the printer 5, the advertisement selecting portion 132 searches a desired size of the customer P1 who made the request from the individual information database 1DM shown in FIG. 23. In addition, an advertisement matching the desired size and the desired information D341′ of the customer P1 shown in FIG. 24 is searched from the advertisement database 1DL. Namely, an advertisement is searched that has the size of one fifth of a page area and is about a personal computer made by F company or about a condominium having a setup of two bed rooms and a living dining room or more in KK ward. Therefore, a leaflet 8e3 is selected. If plural advertisements are obtained from the search, one of them may be selected by comparing the registration date or the expiration date. Alternatively, one of them may be selected at random.

A print data transmitting portion 135 converts the leaflet data D41 of the selected leaflet 8d3 into a print job supported by the printer 5 of the customer P1 similarly to the print data transmitting portion 105 shown in FIG. 4, and the conversion result is transmitted to the printer 5 as the print data D46.

Then, the printer 5 performs a print process in accordance with the print data D46 received from the advertisement delivery apparatus 2C and the print job outputted from the personal computer 5P, so as to output a printed matter 8C as shown in FIG. 25. The upper portion of the printed matter 8C is the advertisement delivered from the advertisement delivery apparatus 2.

The process about the value points is performed by a value calculating portion 136 similarly to the case of the second embodiment. However, the reception points can be varied depending on the advertisement size. For example, the reception points may be set such that two points per ⅕ page, four points per ½ page, ten points per one page that means an advertisement is printed in a full page.

According to this embodiment, in the same way as a banner advertisement that is displayed when browsing a web page by a WWW browser, various advertisements such as the latest product information can be delivered every time when the printer 5 prints a document. Furthermore, since an advertisement is printed as a part of a document of a customer, the customer may see the advertisement repeatedly.

[Fourth Embodiment]

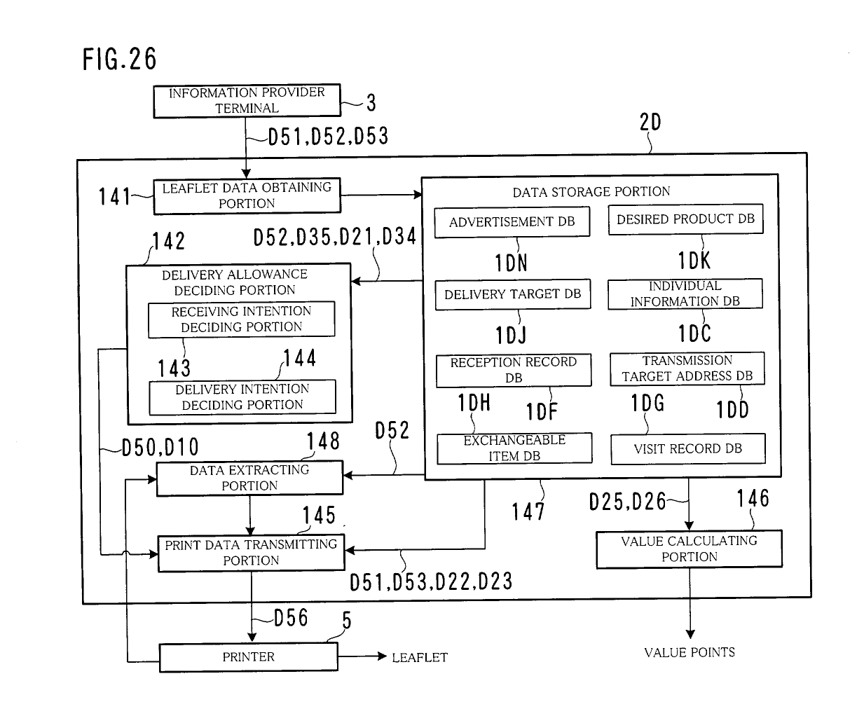

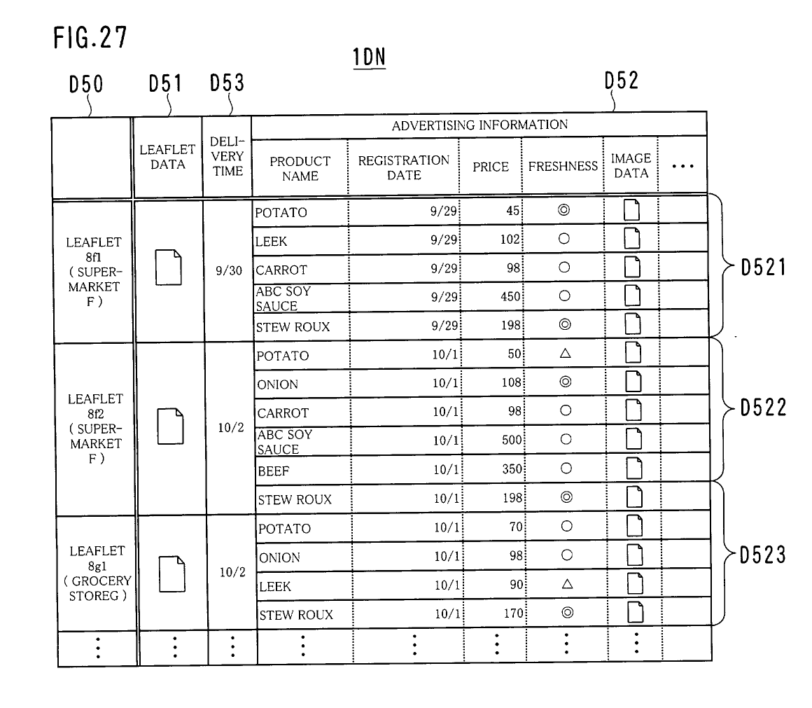

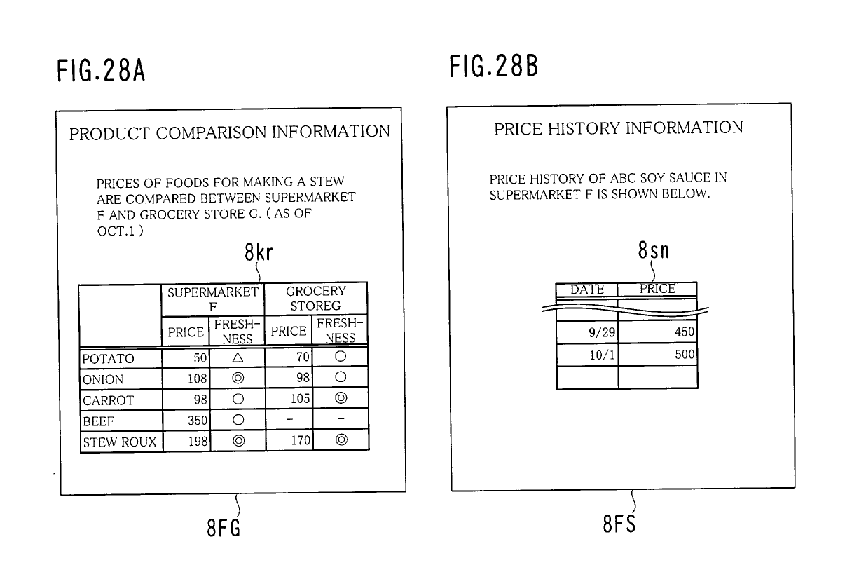

FIG. 26 is a diagram for explaining an example of a functional structure of an advertisement delivery apparatus 2D. FIG. 27 shows an example of an advertisement database 1DN. FIGS. 28A and 28B show examples of a document that describes a comparison table.

In this embodiment, a document describing plural advertisements is delivered to a customer. An advertisement delivery system 1D comprises an advertisement delivery apparatus 2D, an information provider terminal 3 and a communication network 4 similarly to the advertisement delivery system 1C shown in FIG. 20. At least one information provider terminal 3 is installed in a supermarket F or each store such as a grocery store G in a shopping mall B.

The advertisement delivery apparatus 2D comprises a leaflet data obtaining portion 141, a delivery allowance deciding portion 142, a print data transmitting portion 145, a value calculating portion 146, a data storage portion 147 and a data extracting portion 148 as shown in FIG. 26.

The advertisement database 1DN of the data storage portion 147 stores leaflet data D51 and advertising information D52 in relationship with a leaflet name D50 as shown in FIG. 27 and similarly to the advertisement database 1DL shown in FIG. 22. However, since an advertisement (a leaflet) of this embodiment describes plural products, the advertising information D52 includes information about plural products. Other databases of the data storage portion 147 store information similarly to the case of the third embodiment.

The data extracting portion 148 extracts plural advertisements from the advertisement database 1DN responding to a request from a customer, so as to create a comparison table. This process is performed as follows.

For example, it is supposed that a customer selects a stew as a recipe for supper and intends to go out for buying foods to a shopping mall β. The customer checks prices of foods that are sold in a supermarket F and a grocery store G with reference to the latest leaflet of them before going out. The customer operates the personal computer 5P and requests the advertisement delivery apparatus 2D to transmit a document about prices and freshness of foods such as an onion or a potato that are used for making a stew and are sold in the supermarket F and the grocery store G.

Then, the data extracting portion 148 responds to the request and extracts information of foods for making a stew from advertising information D522 and D523 of the latest leaflets 8f2 and 8g1 of the stores. A document creating portion 149 creates a document 8FG describing a comparison table 8kr as shown in FIG. 28A in accordance with the extraction result.

In addition, a customer can study about a price history or a price transition of a specific product described in the advertisement (the leaflet) of the supermarket F in the past. For example, when a customer requests to check a price transition of a soy source whose name is “ABC soy source”, the data extracting portion 148 extracts information of the ABC soy source from the advertising information D52 of the leaflet of the supermarket F that was delivered during a period designated by the customer from the advertisement database 1DN. Then, the document creating portion 149 creates a document 8FS describing a comparison table 8sn as shown in FIG. 28B in accordance with the extraction result.

The print data transmitting portion 145 converts the created document 8FG or 8FS into print data D56 that are supported by the printer 5 of the customer who made the request, and the print data D56 are transmitted to the printer 5. The printer 5 prints the document 8FG or 8FS in accordance with the received print data D56.

The leaflet data obtaining portion 141 performs a process similar to the leaflet data obtaining portion 121 shown in FIG. 16. The value calculating portion 146 performs a process concerning value points similarly to the value calculating portion 126 shown in FIG. 16. However, it is possible to give the reception points in a way different from the first through the third embodiments, e.g., deciding the points in accordance with the number of products described in the document 8FG or 8FS.

Furthermore, a process for delivering one advertisement (one leaflet) to each customer is the same as explained in the second embodiment. Namely, the print data transmitting portion 145 delivers the print data of the leaflet to the printer 5 of the customer who was decided to be delivered by the delivery allowance deciding portion 142.

According to this embodiment, information desired by a customer is extracted from a lot of information, and a document for easily comparing prices or freshness of products described in the leaflets can be provided to customers. The document 8FS may describe not only prices or freshness of products but pictures of the products so that sizes of the products can be compared.

[Fifth Embodiment]

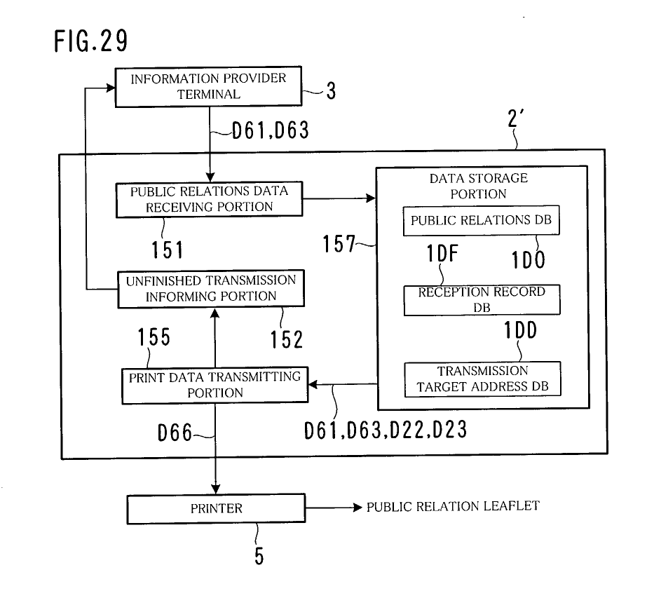

FIG. 29 is a diagram for explaining an example of a functional structure of an advertisement delivery apparatus 2′. The advertisement delivery system 1 of the first embodiment can be used for public relations service of a municipality. Namely, instead of delivering a leaflet to a customer, public relation leaflets of a municipality are delivered to citizens. In this case, the information provider terminal 3 is installed in a public relation room of the municipality building, and the public relation leaflets are delivered to the printers 5 of citizens via the advertisement delivery apparatus 2′. However, the advertisement delivery apparatus 2′ is structured being adapted to the present object as shown in FIG. 29.

A public relations data receiving portion 151 receives public relations data D61 that are image data of the public relations and delivery time information D63 indicating a delivery time of the public relations from the information provider terminal 3 installed in the public relation room. These data are stored in a public relations database 1DO of a data storage portion 157.

A print data transmitting portion 155 converts the public relations data D61 into print data D66 supported by each printer 5 before transmission at the timing indicated in the delivery time information D63 in the same way as the print data transmitting portion 105 shown in FIG. 4. In this way, the public relation leaflets are delivered to citizens.

After that, when receiving a notice of print completion of the public relation leaflet from the printer 5, reception points are given to the owner (citizen) of the printer 5. The reception points are stored in the reception record database 1DF. The citizens can receive a consumable product or others in accordance with the given reception points.

If there is not the notice of the print completion from the printer 5 in a predetermined time after the transmission of the print data D66, the print data transmitting portion 155 performs a recovery process. Namely, the print data D66 are transmitted again to the printer 5. If there is still not the notice from the printer 5 after a predetermined times of repetition of the transmission, an unfinished transmission informing portion 152 informs the information provider terminal 3 of the failure in delivering the public relation leaflet to the citizen of the printer 5. A staff member of a public relation office of the municipality may send the public relation leaflet to the citizen by mail or other means. Thus, the public relation leaflet can be delivered to every citizen.

According to this embodiment, costs for mailing can be reduced largely by delivering a public relation leaflet of a municipality by using the printer 5 of each citizen. In addition, since the printer 5 that could not print the public relation leaflet is noticed to the public relation office, the public relation leaflet can be delivered to every citizen.

If a citizen does not have a printer 5, the public relation leaflet for him/her may be delivered to another printer 5 of his/her neighbor so that the neighbor can pass the public relation leaflet to him/her. In this case, a special reception points may be given to the neighbor.

According to the first through the fifth embodiments, a commercial leaflet or a public relation leaflet can be delivered to each home efficiently, so that an advertising cost or a mailing cost can be reduced. In addition, a printer in each home that may not be used so often usually can be used effectively. The consumable products of the printer are provided by a company or a municipality that made the transmission of the information, so the customer or the citizen can receive the leaflet without worrying about a running cost of the printer. The company or the municipality can use the reduced portion of the cost for a cost of consumable product.

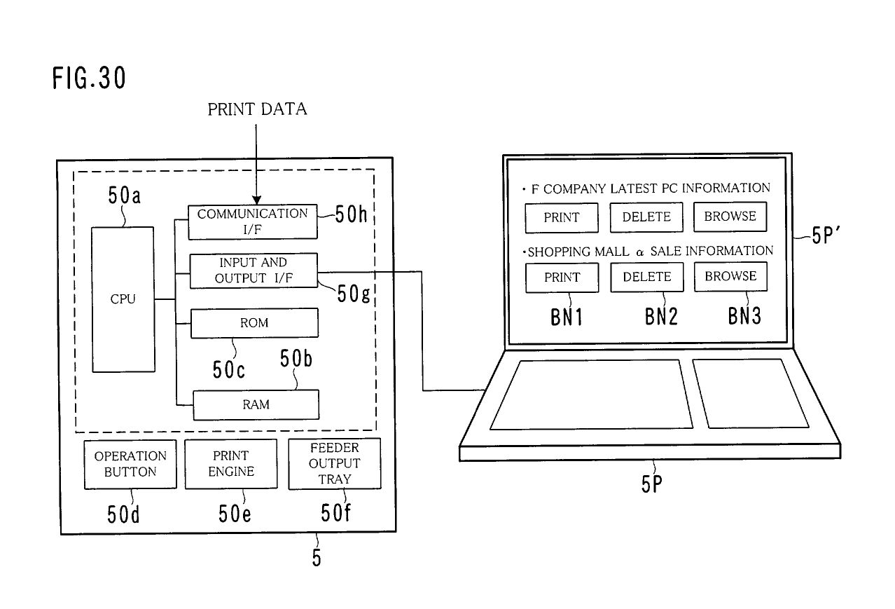

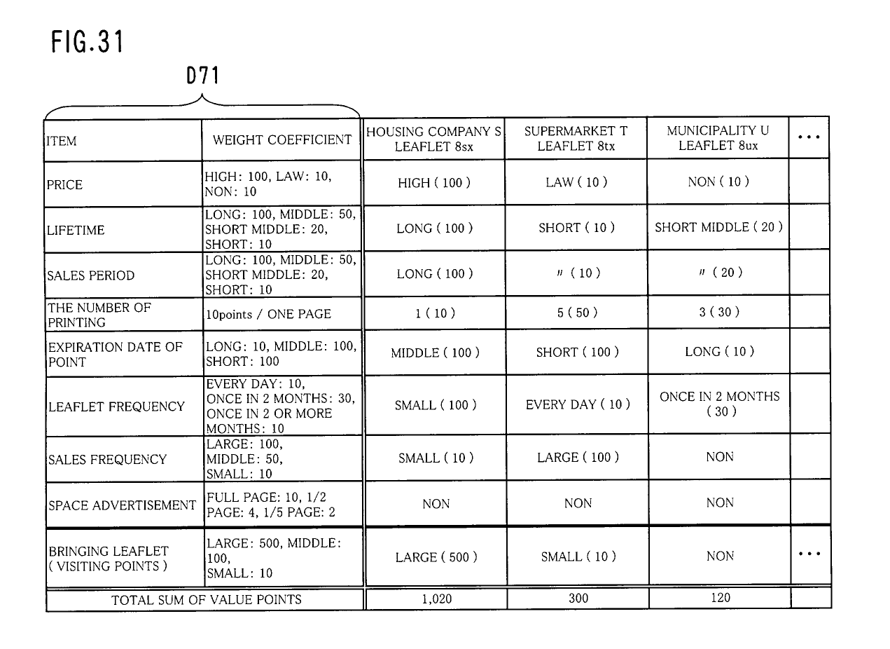

FIG. 30 is a diagram for explaining an example of a structure of a printer 5 and a personal computer 5P′. FIG. 31 is a diagram for explaining an example of a method for calculating the value points.

It is possible in the printer 5 of the first through the fifth embodiments to store the print data received from the advertisement delivery apparatus 2 temporarily in a storing portion such as a RAM, and to select only necessary data for printing. Namely, as shown in FIG. 30, the printer 5 is connected to a personal computer 5P′. Instead of the personal computer 5P′, a cell phone or an information terminal such as a PDA (Personal Digital Assistant) can be connected. A part of the print data received by the printer 5, e.g., a data name is displayed on the display device of the personal computer 5P′. In addition, buttons BN1-BN3 corresponding to each of the print data are displayed.

When the button BN1 is selected, the printer 5 starts the print process in accordance with the print data. When the button BN2 is selected, the print data are deleted from the RAM 50b of the printer 5. When the button BN3 is selected, a print image in the case where the printing is performed in accordance with the print data (a preview screen) is displayed on the display device.

The printer 5 informs the advertisement delivery apparatus 2 of the print completion or the deletion of the print data without printing. When receiving the information of the print completion, the advertisement delivery apparatus 2 stores a genre or a category of the print data that were used for the print in relationship with a customer's name. After that, concerning the customer, a leaflet of the genre or the category has high priority than other leaflets to be delivered. On the contrary, when being informed of deletion of the print data without printing, the priority of a leaflet of the genre or the category of the print data is lowered. Thus, information can be delivered efficiently being adapted to a taste of a customer. Furthermore, an information provider can know the customer's favorite genre, which can be used for reference when delivering information in the future.

It is possible to calculate the reception points for receiving an advertisement (a leaflet) in accordance with point weight information D71 that is stored in the data storage portion 107. Items except the “bringing leaflet” among items of the point weight information D71 shown in FIG. 31 indicate attributions of an advertisement or a customer. For example, an item “price” means a price of a product described in the advertisement, an item “lifetime” means a lifetime of the product, an item “sales frequency” means frequency of shopping of a customer in a store that is a sponsor, and an item “space advertisement” means a ratio of a part of advertisement to a whole space of paper as shown in FIG. 25.

Namely, in order to calculate the reception points, a value for each item of the point weight information D71 is decided, e.g., whether a price of a product described in the advertisement is expensive or cheep, or whether frequency of shopping of a customer to whom the advertisement is delivered is high or middle or low. For example, in the case of the leaflet 8sx of the housing company S, the values are decided in accordance with the contents of the advertisement, e.g., the price is high, the lifetime is long, . . . , the space advertisement is no, and the value of the sales frequency is decided to be high, middle or low for each customer whom the advertisement is delivered.

These values are compared with a weight coefficient of the point weight information D71 so as to decide points of each item. In the case where a leaflet 8sx is delivered to a certain customer, the price is 100, the lifetime is 100, . . . , the sales frequency is 10, and space advertisement is zero. A total sum of these points becomes the reception points. Thus, the reception points can be varied for each of the contents of the advertisement or for each customer who receives the advertisement. Similarly for the case of the public relation leaflet, the reception points can be calculated for each of the contents of the public relation leaflet.

The item “bringing leaflet” of the point weight information D71 means visiting points that are given to a customer who brought a printed advertisement (a leaflet). For example, 500 points are given to a customer who brought the leaflet 8sx.

By calculating the sum of the reception points and the visiting points, the value points to be given to a customer for one advertisement (one leaflet) can be obtained. The customer obtains the value points every time receiving an advertisement and can exchange the accumulated value points over predetermined points for a consumable product of the printer.

In this way, by making a rule for giving reception points or visiting points, it is possible to gather various companies or stores sharing one advertisement delivery system.

It is possible to print accumulated value points of a customer or an expiration date in a header area or a footer area of a leaflet or a public relation leaflet. Thus, a customer's eagerness to buy may be stimulated. Alternatively, it is possible to print information about visiting points that is given to a customer when he/she brings the leaflet to the store, so as to promote customer's visits.

The entire or a part of the structure of the advertisement delivery systems 1, 1B, 1C or 1D, the advertisement delivery apparatus 2 or 2′, 2B, 2C or 2D, the information provider terminal 3, the communication network 4 or the printer 5, the contents or the order of the process can be modified in the scope of the present invention.

According to the present invention, delivery of an advertisement can be performed more efficiently and more effectively than the conventional method. In addition, printers that are usually used not so often can be used effectively.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. An advertisement delivery system comprising:
an advertisement database for storing advertising information that indicates contents that a sponsor wants to advertise for each advertisement that the sponsor requested to deliver;
an interest information database for storing interest information that indicates interests of each consumer;
an address database for storing network addresses of printers for printing the advertisement for each of the consumer;
a receiving intention deciding portion for deciding whether or not the consumer has an intention to receive the advertisement in accordance with the interest information of the consumer and the advertising information of the advertisement;
a print data transmission portion for transmitting print data for printing the advertisement to the network address of the consumer if the receiving intention deciding portion decides that the consumer has an intention to receive the advertisement;
a reception record database for storing reception record information that indicates records of each consumer's reception of the advertisement; and
a value calculating portion for calculating value that is given to the consumer as compensation for receiving the advertisement in accordance with the reception record information of the consumer.

2. The advertisement delivery system according to claim 1, further comprising:
a delivery target database for storing delivery target information that indicates delivery targets for each advertisement;
an individual information database for storing individual information of each consumer; and
a delivery intention deciding portion for deciding whether or not the sponsor of the advertisement has an intention to deliver the advertisement to the consumer in accordance with the delivery target information of the advertisement and the individual information of the consumer, wherein the print data transmission portion transmits the print data of the advertisement only to the network address of consumers who are decided to have an intention to receive the advertisement by the receiving intention deciding portion if it is decided by the delivery intention deciding portion that the sponsor of the advertisement has an intention to deliver the advertisement to the consumers.

3. The advertisement delivery system according to claim 1, further comprising a contact record database for storing contact record information that indicates records of each consumer's contact with the sponsor of the advertisement by seeing printed matter of the advertisement printed by the printer, wherein the value calculating portion calculates the value that is given to the consumer in accordance with the contact record information of the consumer.

4. The advertisement delivery system according to claim 1, further comprising a weight information storing portion for storing weight information that indicates weight of the compensation for each attribution of the advertisement, wherein the value calculating portion calculates the value for receiving the advertisement by adding points obtained by converting a value that indicates each attribution of the advertisement in accordance with the weight information corresponding to each attribution.

5. The advertisement delivery system according to claim 1, wherein the print data transmission portion responds to a request from the printer and transmits the print data of the advertisement that is printed together with documents by the printer to the network address of the printer.

6. An advertisement delivery system comprising:
an advertisement database for storing advertising information that indicates contents that a sponsor wants to advertise for each advertisement that the sponsor requested to deliver;
an interest information database for storing interest information that indicates interests of each consumer;
an address database for storing network addresses of printers for printing the advertisement for each of the consumer;
a desired advertisement selecting portion for selecting an advertisement that the consumer has an intention to receive among plural advertisements that describe the same service in accordance with the advertising information of the plural advertisements and the interest information of the consumer;
a print data transmission portion for transmitting print data for printing the advertisement selected by the desired advertisement selecting portion to the network address of the consumer;
a reception record database for storing reception record information that indicates records of each consumer's reception of the advertisement; and
a value calculating portion for calculating value that is given to the consumer as compensation for receiving the advertisement in accordance with the reception record information of the consumer.

7. An advertisement delivery system comprising:
an advertisement database for storing price information for each service described in an advertisement that is requested by a sponsor to deliver;
an address database for storing network addresses of printers for each consumer;
an extracting portion for extracting the price information of a service designated by the consumer for each plural advertisements designated by the consumer;
a document creating portion for creating a document describing prices of the designated services that are described in the designated plural advertisements in accordance with the price information extracted by the extracting portion;
a print data transmission portion for transmitting print data for printing the document to the network address of the consumer who made the designation;
a reception record database for storing reception record information that indicates records of each consumer's reception of the document; and
a value calculating portion for calculating value that is given to the consumer as compensation for receiving the document in accordance with the reception record information of the consumer.

8. An advertisement delivery system comprising:
an advertisement database for storing price information for each service described in an advertisement that is requested by a sponsor to deliver;
an address database for storing network addresses of printers for each consumer;
an extracting portion for extracting the price information of a service designated by the consumer for each of the advertisement up to now of a sponsor designated by the consumer;
a document creating portion for creating a document describing price history of the designated service of the designated sponsor in accordance with the price information extracted by the extracting portion;
a print data transmission portion for transmitting print data for printing the document to the network address of the consumer who made the designation;
a reception record database for storing reception record information that indicates records of each consumer's reception of the document; and
a value calculating portion for calculating value that is given to the consumer as compensation for receiving the document in accordance with the reception record information of the consumer.

9. A print system that is connected via a network to an advertisement delivery system for delivering advertisement data for printing an advertisement, the print system comprising:
a request portion for responding to an instruction of printing a document and for requesting the advertisement delivery system via the network to transmit the advertisement data of an advertisement to be printed together with the document; and
a printing portion for printing the document together with the advertisement in accordance with the advertisement data that was received via the network from the advertisement delivery system.

10. A record medium for recording a computer program that is used for a computer that deliver advertisement to a consumer in accordance with a request of a sponsor, the computer program makes the computer execute the process comprising the steps of:
deciding whether or not the consumer has an intention to receive the advertisement in accordance with interest information that indicates interests of each consumer and advertisement information that indicates contents of the advertisement;
transmitting print data for printing the advertisement to a printer of the consumer when it is decided that the consumer has an intention to receive the advertisement;
updating reception record information that indicates records of the consumer's reception of the advertisement after transmitting the print data; and
calculating value that is given to the consumer as compensation for receiving the advertisement in accordance with the reception record information of the consumer.
